(19) United States
(12) Patent Application Publication
(10) Pub. No.: US 2022/0225604 A1
(43) Pub. Date: Jul. 21, 2022

(54) SYSTEM AND METHOD FOR DISPENSING AGRICULTURAL FLUIDS ONTO PLANTS PRESENT WITHIN A FIELD BASED ON PLANT SIZE

(71) Applicant: CNH Industrial America LLC, New Holland, PA (US)

(72) Inventor: Andrew W. Harmon, Sheboygan, WI (US)

(73) Assignee: CNH Industrial America LLC

(21) Appl. No.: 17/149,868

(22) Filed: Jan. 15, 2021

(51) Int. Cl. A01M 7/00; G05B 19/05

(52) U.S. Cl. CPC A01M 7/0089; A01M 7/0085; A01M 7/0042; G05B 2219/15053; G05B 19/05; G05B 2219/15048; A01M 7/006

(57) ABSTRACT

A system for dispensing agricultural fluids onto plants present within a field includes a sensor configured to capture data associated with the plant and a computing system communicatively coupled to the sensor. In this respect, the computing system is configured to receive an input associated with the pesticide present within the agricultural fluid. Furthermore, the computing system is configured to determine a size parameter associated with the plant based on the data captured by the sensor. Moreover, the computing system is configured to determine a selected amount of the pesticide to be dispensed onto the plant based on determined size parameter and the received input associated with the pesticide. Additionally, the computing system is configured to control an operation of the nozzle such that a volume of the agricultural fluid containing the selected amount of the pesticide is dispensed onto the plant.

### FIELD OF THE INVENTION

The present disclosure generally relates to agricultural sprayers and, more particularly, to systems and methods for selectively dispensing agricultural fluids, such as a pesticide, onto plants (e.g., weeds) present within a field based on a size parameter associated with such plants.

### BACKGROUND OF THE INVENTION

Agricultural sprayers are self-propelled vehicles or towable implements that travel across an agricultural field to apply an agricultural fluid onto the plants and/or soil present within the field. Traditionally, agricultural sprayers have only been capable of dispensing the agricultural fluid at a constant rate across the swath of the field along which the sprayer is traveling. In this respect, such sprayers may apply the agricultural substance to plants and/or portions of the soil that do not need the agricultural substance, thereby wasting the agricultural substance. For example, such a sprayer may apply a herbicide to portions of the field where no weeds are present.

In this respect, systems have been developed that allow a sprayer to selectively apply the agricultural substance to only the plants or portions of the soil that need the agricultural substance. For example, some of these systems may identify specific weeds present with the field and control the operation of the sprayer such that a herbicide is applied only to the identified weeds, thereby dramatically reducing the amount of herbicide used. However, the amount of pesticide needed to effectively kill a specific weed can vary. Thus, conventional systems typically apply pesticide at a rate set to kill the largest and heartiest weeds present in the field, which may result in overapplying pesticide to smaller weeds.

Accordingly, an improved system and method for selectively dispensing agricultural fluids onto plants present within a field would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for dispensing agricultural fluids onto plants present within a field. The system includes a tank configured to store an agricultural fluid including a pesticide and a carrier fluid and a nozzle configured to selectively dispense the agricultural fluid onto a plant present within the field. Furthermore, the system includes a sensor configured to capture data associated with the plant and a computing system communicatively coupled to the sensor. In this respect, the computing system is configured to receive an input associated with the pesticide present within the agricultural fluid. Additionally, the computing system is configured to determine a size parameter associated with the plant based on the data captured by the sensor. Moreover, the computing system is configured to determine a selected amount of the pesticide to be dispensed onto the plant based on determined size parameter and the received input associated with the pesticide. In addition, the computing system is configured to control an operation of the nozzle such that a volume of the agricultural fluid containing the selected amount of the pesticide is dispensed onto the plant.

In another aspect, the present subject matter is directed to an agricultural sprayer. The agricultural sprayer includes a frame, a tank supported on the frame, with the tank configured to store an agricultural fluid including a pesticide and a carrier fluid. Furthermore, the agricultural sprayer includes a boom assembly supported on the frame and a plurality of nozzles supported on the boom assembly, with each nozzle configured to selectively dispense the agricultural fluid onto a plant present within the field. Additionally, the agricultural sprayer includes a sensor configured to capture data associated with the plant and a computing system communicatively coupled to the sensor. In this respect, the computing system is configured to receive an input associated with the pesticide present within the agricultural fluid. Moreover, the computing system is configured to determine a size parameter associated with the plant based on the data captured by the sensor. In addition, the computing system is configured to determine a selected amount of the pesticide to be dispensed onto the plant based on determined size parameter. Furthermore, the computing system is configured to determine a selected nozzle of the plurality of nozzles to dispense the selected amount of the pesticide and the received input associated with the pesticide. Additionally, the computing system is configured to control an operation of the selected nozzle such that a volume of the agricultural fluid containing the selected amount of the pesticide is dispensed by the selected nozzle onto the plant.

In a further aspect, the present subject matter is directed to a method for dispensing agricultural fluids onto plants present within a field. The method includes receiving, with a computing system, an input associated with a pesticide present within the agricultural fluid, with the agricultural fluid further including a carrier fluid. Furthermore, the method includes receiving, with the computing system, sensor data associated with a plant present within the field. Additionally, the method includes determining, with the computing system, a size parameter associated with the plant based on the received sensor data. Moreover, the method includes determining, with the computing system, a selected amount of the pesticide to be dispensed onto the plant based on determined size parameter and the received input associated with the pesticide. In addition, the method includes controlling, with the computing system, an operation of a nozzle such that a volume of the agricultural fluid containing the selected amount of the pesticide is dispensed onto the plant.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural sprayer in accordance with aspects of the present subject matter;

FIG. 2 illustrates a partial front view of a boom assembly of an agricultural sprayer in accordance with aspects of the present subject matter;

FIG. 3 illustrates a schematic view of one embodiment of a system for dispensing agricultural fluids onto plants present within a field in accordance with aspects of the present subject matter; and

FIG. 4 illustrates a flow diagram of one embodiment of a method for dispensing agricultural fluids onto plants present within a field in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for dispensing agricultural fluids onto plants present within a field. Specifically, in several embodiments, the disclosed system may include one or more nozzles of an agricultural sprayer. Each nozzle may, in turn, be configured to selectively dispense an agricultural fluid onto plants present within the field. In general, the agricultural fluid may include a pesticide (e.g., a herbicide) and a carrier fluid (e.g., water). Furthermore, the system may include one or more sensors (e.g., an imaging device(s), such as a camera(s)) configured to capture data associated with the plants present within the field. As will be described below, the computing system may analyze the data captured by the sensor(s) to identify specific plants (e.g., weeds) present within the field and control the operation of the nozzle(s) such that the agricultural fluid is dispensed onto or otherwise applied to the identified plants.

The disclosed system may be configured to control the amount of pesticide applied to the identified plants based on the size of such plants. More specifically, the computing system may receive an input (e.g., from an operator of the sprayer) associated with the pesticide present within the agricultural fluid. For example, the input may be indicative of the type and/or concentration of the active ingredient present within the pesticide. Furthermore, the computing system may determine a size parameter(s) associated with each identified plant based on the captured sensor data. Exemplary size parameters include the height, circumference, stalk diameter, and biomass of the identified plants. In this respect, the computing system determines a selected amount of the pesticide to be dispensed onto each identified plant based on its determined size parameter(s) and the received input associated with the pesticide. The selected amount of the pesticide is, in turn, an amount of pesticide that is sufficient to kill the identified plant without being significantly more than is necessary. Thereafter, the computing system may control the operation of the sprayer nozzle(s) (e.g., its/their duty cycle) such that one of the nozzles dispenses a volume of the agricultural fluid containing the corresponding selected amount of the pesticide onto each plant. As such, the disclosed system allows the amount of pesticide applied to a plant present within the field to be adjusted based on the plant size such that enough pesticide and, more specifically, its active ingredient(s) is applied to kill the plant without overapplying and wasting pesticide.

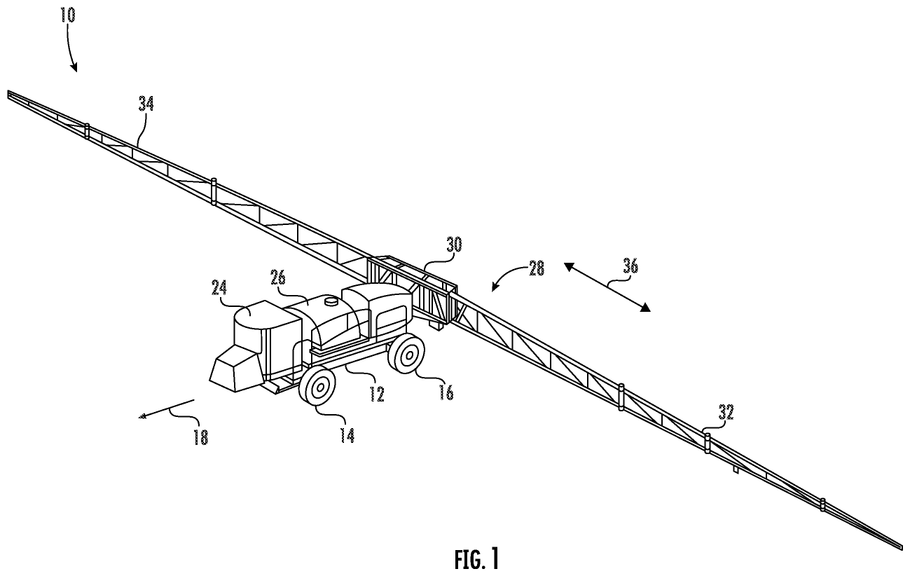

Referring now to FIG. 1, a perspective view of one embodiment of an agricultural sprayer 10 is illustrated in accordance with aspects of the present subject matter. In the illustrated embodiment, the agricultural sprayer 10 is configured as a self-propelled agricultural sprayer. However, in alternative embodiments, the agricultural sprayer 10 may be configured as any other suitable type of agricultural sprayer, such as a towable agricultural sprayer.

As shown in FIG. 1, the agricultural sprayer 10 may include a frame or chassis 12 configured to support or couple to a plurality of components. For example, a pair of steerable front wheels 14 (one is shown) and a pair of driven rear wheels 16 (one is shown) may be coupled to the frame 12. The wheels 14, 16 may be configured to support the agricultural sprayer 10 relative to the ground and move the agricultural sprayer 10 in a direction of travel (indicated by arrow 18 in FIG. 1) across a field. In this regard, the agricultural sprayer 10 may include an engine (not shown) and a transmission (not shown) configured to transmit power from the engine to the wheels 14, 16. Furthermore, the frame 12 may also support an operator's cab 24 housing various control or input devices (e.g., levers, pedals, control panels, buttons and/or the like) for permitting an operator to control the operation of the sprayer 10.

Additionally, the agricultural sprayer 10 may include a tank 26 supported on the frame 12. In general, the tank 26 may be configured to store or hold an agricultural fluid to be dispensed as the sprayer 10 travels across a field. Specifically, the agricultural fluid may be formed from a pesticide and carrier fluid (e.g., water). The pesticide may, in turn, have one or more active ingredients and one or more inactive ingredients. In several embodiments, the pesticide may be a herbicide. In such embodiments, the active ingredients of the herbicide may damage or otherwise interfere with the properly functioning of one or more species of plants.

Moreover, the agricultural sprayer 10 may include a boom assembly 28 mounted on the frame 12. As shown, in one embodiment, the boom assembly 28 includes a center boom 30 and a pair of wing booms 32, 34 extending outwardly from the center boom 30 along a lateral direction 36, with the lateral direction 36 extending generally perpendicular the direction of travel 18. As will be described below, a plurality of nozzles 38 may be mounted or otherwise supported on the boom assembly 28 to dispense the agricultural fluid stored in the tank 26 onto the underlying plants and/or soil. However, in alternative embodiments, the boom assembly 28 may include any other suitable number and/or configuration of boom sections, such as more or fewer than three boom sections.

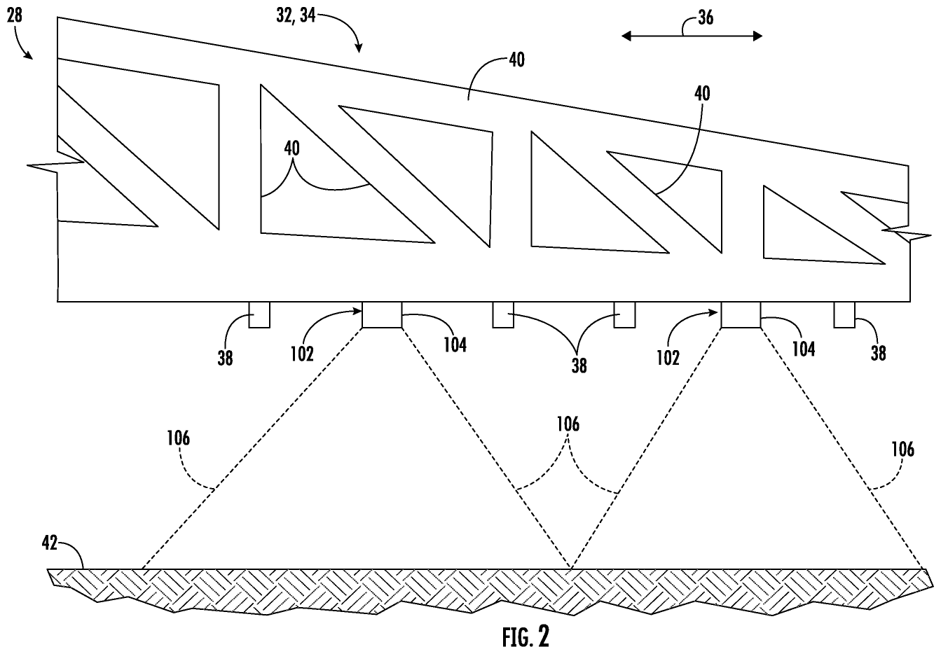

Referring now to FIG. 2, a partial front view of one embodiment of a boom assembly 28 is illustrated in accordance with aspects of the present subject matter. In general, the boom assembly 28 may include a plurality of structural frame members 40, such as beams, bars, and/or the like. Moreover, as mentioned above, the boom assembly 28 may support a plurality of nozzles 38. Each nozzle 38 may, in turn, be configured to selectively dispense a volume of the agricultural fluid stored within the tank 26 (FIG. 1) onto plants present within the field. Specifically, as shown, the nozzles 38 are mounted on and/or coupled to the frame members 40 such that the nozzles 38 are spaced apart from each other in the lateral direction 36. Furthermore, fluid conduit(s) (not shown) may fluidly couple the nozzles 38 to the tank 26 (FIG. 1) and an associated pump (not shown). In this respect, as the sprayer 10 travels across the field in the direction of travel 18 to perform a spraying operation thereon, the pump may pump the agricultural fluid from the tank 22 through the fluid conduit(s) to each of the nozzles 38. As will be described below, the operation of the nozzles 38 may be selectively controlled such that the nozzles 38 dispense the agricultural fluid onto specific plants (e.g., weeds) identified within the field 42. Although the embodiment of the boom assembly 28 shown in FIG. 2 includes four nozzles 38, the boom assembly 28 may, in other embodiments, include any other suitable number of nozzles 38.

It should be appreciated that the configuration of the work vehicle 10 described above and shown in FIGS. 1 and 2 are provided only to place the present subject matter in an exemplary field of use. Thus, it should be appreciated that the present subject matter may be readily adaptable to any manner of agricultural sprayer configuration. For example, in some embodiments, the front wheels 14 of the sprayer 10 may be driven in addition to or lieu of the rear wheels 16.

In accordance with aspects of the present subject matter, one or more plant sensors 102 may be installed on the sprayer 10. In general, the plant sensor(s) 102 may be configured to capture data indicative of one or more plants present within the field across which the sprayer 10 is traveling. As will be described below, a computing system may be configured to analyze the captured data to identify the location(s) of one or more plants (e.g., weeds) present within the field and determine of or more size parameters associated with the identified plant(s). Thereafter, the determined size parameter(s) may be used to control the operation of one or more of the nozzles 38 such that a volume(s) of the agricultural fluid is applied to the identified plant(s).

In general, the plant sensor(s) 102 may correspond to any suitable sensing device(s) configured to detect or capture data indicative of or otherwise associated with the plants present within the field 42. Specifically, in several embodiments, the plant sensor(s) 102 may be configured as an imaging device(s) 104 configured to detect or capture images or other image-like data depicting the plants present within the field 42. For example, in one embodiment, the imaging device(s) 104 may correspond to a suitable camera(s), such as a stereographic camera(s), configured to capture three-dimensional images of the plants present within its field of view (indicated by dashed lines 106). However, in alternative embodiments, the imaging device(s) 104 may correspond to any other suitable sensing device(s) configured to capture image or image-like data, such as a monocular camera(s), a LIDAR sensor(s), and/or a RADAR sensor(s). Moreover, in further embodiments, the plant sensor(s) 102 may correspond to any other suitable sensing device(s).

The plant sensor(s) 102 may be installed at any suitable location(s) that allow the plant sensor(s) 102 to capture data associated with the plants present within the field 42. For example, in some embodiments, the plant sensor(s) 102 may be mounted on wing booms 32, 34 of the boom assembly 28. However, in alternative embodiments, the plant sensor(s) 102 may be installed at any other suitable location(s), such as on the roof of the cab 20 (FIG. 1) or the center boom section 30. Additionally, any suitable number of plant sensors 102 may be installed on the sprayer 10.

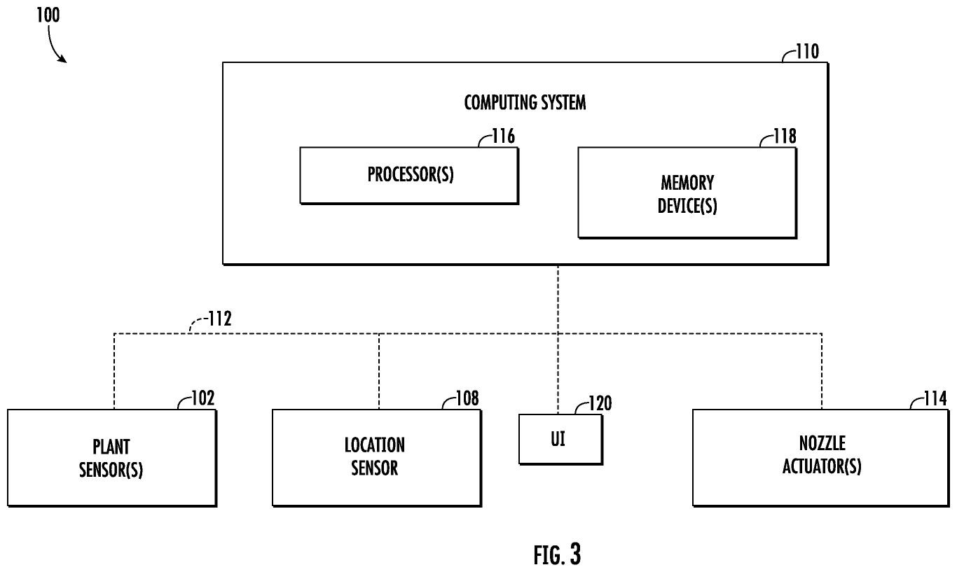

Referring now to FIG. 3, a schematic view of one embodiment of a system 100 for dispensing agricultural fluids onto plants present within a field is illustrated in accordance with aspects of the present subject matter. In general, the system 100 will be described herein with reference to the agricultural sprayer 10 described above with reference to FIGS. 1 and 2. However, it should be appreciated by those of ordinary skill in the art that the disclosed system 100 may generally be utilized with agricultural sprayers having any other suitable sprayer configuration.

As shown in FIG. 3, the system 100 may include a location sensor 108 may be provided in operative association with the agricultural sprayer 10. In general, the location sensor 108 may be configured to determine the location of the sprayer 10 using a satellite navigation positioning system (e.g., a GPS system, a Galileo positioning system, the Global Navigation satellite system (GLONASS), the BeiDou Satellite Navigation and Positioning system, and/or the like). As such, the location determined by the location sensor 108 may be transmitted to a computing system 110 of the system 100 (e.g., in the form coordinates) and stored within the computing system's memory for subsequent processing and/or analysis.

In accordance with aspects of the present subject matter, the system 100 may include a computing system 110 communicatively coupled to one or more components of the sprayer 10 and/or the system 100 to allow the operation of such components to be electronically or automatically controlled by the computing system 110. For instance, the computing system 110 may be communicatively coupled to the plant sensor(s) 102 via a communicative link 112. As such, the computing system 110 may be configured to receive data from the plant sensor(s) 102 that is indicative of one or more plants present within the field. Furthermore, the computing system 110 may be communicatively coupled to location sensor 108 via the communicative link 112. As such, the computing system 110 may be configured to receive data from the location sensor 108 that is indicative of the location of the sprayer 10 within the field. Moreover, the computing system 110 may be communicatively coupled to a nozzle actuator(s) 114 (e.g., a solenoid(s)) associated with the nozzle(s) 38 via the communicative link 1112. In this respect, the computing system 110 may be configured to control the nozzle actuator(s) 114 in a manner that controls the operation of the nozzle(s) 38. As will be described below, the computing system 110 may be configured to control the nozzle actuator(s) 114 in a manner that adjusts the duty cycle(s) of the nozzle(s) 38 to dispense a selected amount of the agricultural fluid. Additionally, the computing system 110 may be communicatively coupled to any other suitable components of the sprayer 10 and/or the system 100.

In general, the computing system 110 may comprise one or more processor-based devices, such as a given controller or computing device or any suitable combination of controllers or computing devices. Thus, in several embodiments, the computing system 110 may include one or more processor(s) 116 and associated memory device(s) 118 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 118 of the computing system 110 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 118 may generally be configured to store suitable computer-readable instructions that, when implemented by the processor(s) 116, configure the computing system 110 to perform various computer-implemented functions, such as one or more aspects of the methods and algorithms that will be described herein. In addition, the computing system 110 may also include various other suitable components, such as a communications circuit or module, one or more input/output channels, a data/control bus and/or the like.

The various functions of the computing system 110 may be performed by a single processor-based device or may be distributed across any number of processor-based devices, in which instance such devices may be considered to form part of the computing system 110. For instance, the functions of the computing system 110 may be distributed across multiple application-specific controllers or computing devices, such as a navigation controller, an engine controller, and/or the like.

In addition, the system 100 may also include a user interface 120. More specifically, the user interface 120 may be configured to receive inputs (e.g., inputs associated with the pesticide present within the tank 26) from the operator. As such, the user interface 120 may include one or more input devices, such as touchscreens, keypads, touchpads, knobs, buttons, sliders, switches, mice, microphones, and/or the like, which are configured to receive user inputs from the operator. The user interface 120 may, in turn, be communicatively coupled to the computing system 110 via the communicative link 112 to permit the received inputs to be transmitted from the user interface 120 to the computing system 110. In addition, some embodiments of the user interface 120 may include one or more feedback devices (not shown), such as display screens, speakers, warning lights, and/or the like, which are configured to provide feedback from the computing system 120 to the operator. In one embodiment, the user interface 120 may be mounted or otherwise positioned within the cab 24 of the sprayer 10. However, in alternative embodiments, the user interface 120 may mounted at any other suitable location.

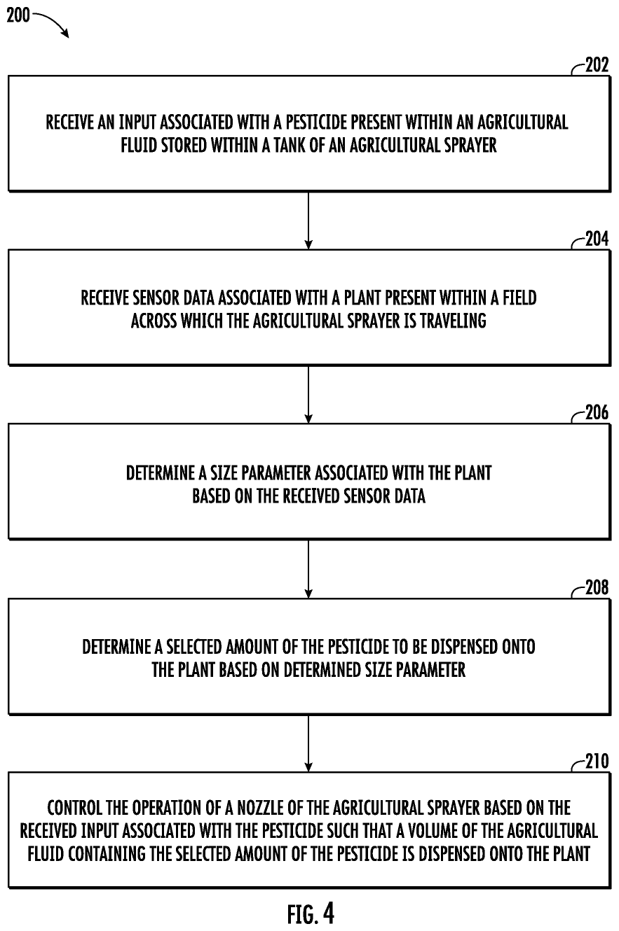

Referring now to FIG. 4, a flow diagram of one embodiment of a method 200 for dispensing agricultural fluids onto plants present within a field is illustrated in accordance with aspects of the present subject matter. In general, the method 200 will be described herein with reference to the agricultural sprayer 10 and the system 100 described above with reference to FIGS. 1-3. However, it should be appreciated by those of ordinary skill in the art that the disclosed method 200 may generally be implemented with any agricultural sprayer having any suitable sprayer configuration and/or within any system having any suitable system configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), the method 200 may include receiving, with a computing system, an input associated with a pesticide present within an agricultural fluid stored within a tank of an agricultural sprayer. Specifically, in several embodiments, the operator of the agricultural sprayer 10 may provide one or more inputs to the user interface 120 associated with the pesticide present within the tank 26. The input(s) from the operator may then be transmitted from the user interface 120 to the computing system 110 via the communicative link 112.

The input(s) received at (202) may be any suitable input(s) associated with the pesticide. In some embodiments, the input(s) may be associated with the active ingredient(s) present within the pesticide contained within the tank 26. For example, the operator may provide the type(s) and/or concentration(s) of the active ingredient(s) present within the pesticide and/or the concentration of the pesticide within the agricultural fluid. As will be described below, based on such input(s), the computing system 100 may be configured to determine the volume of agricultural fluid to be applied to a given plant (e.g., weed) to kill the plant without overapplying and wasting the agricultural fluid.

Furthermore, at (204), the method 200 may include receiving, with the computing system, sensor data associated with a plant present within a field across which the agricultural sprayer is traveling. More specifically, as the sprayer 10 travels across a field to perform a spraying operation, the computing system 110 may receive data associated with the plants (e.g., weeds) present within the field from the plant sensor(s) 102 (e.g., via the communicative link 112). For example, as mentioned above, in some embodiments, the plant sensor(s) 102 may be configured as imaging device(s) 104. In such embodiments, the computing system 110 may be configured to receive images depicting a portion(s) of the field forward of the nozzles 38 of the sprayer 10.

Additionally, as shown in FIG. 4, at (206), the method 200 may include determining, with the computing system, a size parameter associated with the plant based on the received sensor data. Specifically, in several embodiments, the computing system 110 may analyze the sensor data received at (204) to identify one or more plants present within the field, determine the location of the identified plant(s) (e.g., relative to the corresponding plant sensor 102), and determine one or more size parameters associated with the identified plant(s). The identified plants may, in turn, be weeds or other plants on which the operator of the sprayer 10 would like to selectively dispense or apply the pesticide stored in the tank 26. As will be described below, the computing system 110 may determine a selected amount of pesticide to be applied to each identified plant based on its determined size parameter(s) and the input associated with the pesticide. Thereafter, the computing system 110 may control the operation of one or more of the nozzles 38 mounted on the sprayer 10 such that a volume of the agricultural fluid containing the corresponding selected amount of the pesticide is dispensed onto each identified plant.

As mentioned above, in some embodiments, the data received at (204) may be image data depicting a portion of the field across which the sprayer 10 is traveling. In such embodiments, at (206), the computing system 110 may analyze the received image data using any suitable image analysis techniques to identify one or more plants depicted within the image data on which the operator of the sprayer 10 would like to selectively apply the pesticide. For example, in one embodiment, the computing system 110 may identify one or more weeds depicted within the image data. Thereafter, the computing system 110 may further analyze the received image data to determine the location of each identified plant (e.g., relative to the corresponding imaging device 104) and determine an associated size parameter(s) for each identified plant.

The determined size parameter(s) may be any suitable parameter associated with the size of an identified plant present within the field. For example, in several embodiments, the size parameter(s) may correspond to the height of the plant, the circumference of the plant, the stalk diameter of the plant, the biomass of the plant, and/or the like.

Furthermore, in some embodiments, at (206), the method 200 may include comparing the determined size parameter(s) to a corresponding maximum parameter value. More specifically, some weeds or other plants present within the field may be too large to effectively kill with a volume of pesticide that is able to be dispensed from the sprayer 10 during a spraying operation. Applying too little pesticide to such large weeds may create chemical resistance to the pesticide. As such, these weeds may need to be mechanically removed (e.g., via a tillage operation or by hand). In this respect, the computing system 110 may compare the determined size parameter(s) for each identified plant to an associated maximum parameter value. When the determined size parameter(s) for a plant exceeds the corresponding maximum parameter value (thereby indicating that the identified plant is too large to be killed by the pesticide from the sprayer 10), the computing system 110 may control the operation of the nozzles 38 on the sprayer 10 to prevent any agricultural fluid from being dispensed onto that plant. For example, the computing system 110 may transmit control signals (e.g., via the communicative link 112) the nozzle actuators 114 instructing the nozzle actuators 114 to close the associated the nozzles 38, thereby preventing the discharge of agricultural fluid onto the plant. Thereafter, the computing system 110 may initiate or otherwise provide a notification to the operator of the sprayer 10 (e.g., via the user interface 120) that a plant having a size parameter(s) greater than the associated maximum value has been encountered.

In addition, when the determined size parameter(s) for a plant exceeds the corresponding maximum parameter value, the method 200 may, at (206), include geolocating the plant. More specifically, as the sprayer 10 travels across the field, the computing system 110 may be configured to receive location data (e.g., coordinates) from the location sensor 108 (e.g., via the communicative link 112). Based on the known dimensional configuration and/or relative positioning between the identified plant, associated plant sensor 102, and the location sensor 108, the computing system 110 may geo-locate each identified plant having a size parameter(s) exceeding the corresponding maximum parameter value within the field. For example, in one embodiment, the coordinates derived from the location sensor 108 and the plant identifications derived from the plant sensor(s) 102 may both be time-stamped. In such an embodiment, the time-stamped data may allow the plant identifications to be matched or correlated to a corresponding set of location coordinates received or derived from the location sensor 108.

Additionally, at (208), the method 200 may include determining, with the computing system, a selected amount of the pesticide to be dispensed onto the plant based on determined size parameter. More specifically, the amount of pesticide necessary to kill a plant varies depending on the size of the plant. That is, larger plants generally require more pesticide (to kill than smaller plants. Moreover, the type of the active ingredient(s) and the concentration of the active ingredient(s) within the pesticide may also affect the amount of pesticide needed to kill a plant. For example, weaker concentrations of the active ingredient(s) within the pesticide may require applying more agricultural fluid to a plant to kill it. In this respect, the amount of pesticide needed to effectively kill a plant without overapplying and wasting pesticide may vary based on the size of the plant and the type and concentration of the active ingredients of the pesticide. As such, in several embodiments, the computing system 110 may determine a selected amount of the pesticide and, more specifically, a selected amount of the active ingredient(s) to be dispensed onto each identified plant based on its size parameter(s) determined at (206) and the input associated with the pesticide received at (202). For instance, the computing system 110 may include a look-up table(s), suitable mathematical formula, and/or an algorithm(s) stored within its memory device(s) 118 that correlates the received input with the pesticide and the determined size parameter(s) to the corresponding selected amount of the pesticide.

Moreover, as shown in FIG. 4, at (210), the method may include controlling, with the computing system, the operation of a nozzle of the agricultural sprayer such that a volume of the agricultural fluid containing the selected amount of the pesticide is dispensed onto the plant. In several embodiments, the computing system 110 may be configured to control the operation of the nozzles 38 of the sprayer 10 such that a volume of the agricultural fluid containing the corresponding selected amount of the pesticide is dispensed onto each identified plant. More specifically, the computing system 110 may, for a given identified plant, determine a selected nozzle of the nozzles 38 to dispense the selected amount of the pesticide onto the given plant based on the determined location of the given plant. For example, the selected nozzle may be the nozzle 38 closest to the given plant. Furthermore, the computing system 110 may determine a volume of the agricultural fluid containing the corresponding selected amount of the pesticide (e.g., based on the concentration of the pesticide or its active ingredient(s) within the agricultural fluid). For instance, the computing system 110 may include a look-up table(s) stored within its memory device(s) 118 that correlates the selected amount of the pesticide (or active ingredient(s)) with the volume of the agricultural fluid. Thereafter, the computing system 110 may control the operation of the selected nozzle 38 (e.g., its duty cycle) such that the determined volume of the agricultural fluid containing the selected amount of the pesticide is dispensed onto the given plant. For example, in one embodiment, the computing system 110 may transmit control signals (e.g., via the communicative link 112) to the nozzle actuator 114 of the selected nozzle 38. The control signals may, in turn, instruct the nozzle actuator 114 to open the selected nozzle 38 such that the volume of the agricultural fluid containing the corresponding selected amount of the pesticide is dispensed onto the given plant. As such, the system 100 allows the amount of pesticide applied to each identified plant (e.g., weed) present within the field to be adjusted based on the plant size such that enough pesticide and, more specifically, its active ingredient(s) is applied to kill the plant without overapplying and wasting pesticide.

It is to be understood that the steps of the method 200 are performed by the computing system 100 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 100 described herein, such as the method 200, is implemented in software code or instructions which are tangibly stored on a tangible computer readable medium. The computing system 100 loads the software code or instructions via a direct interface with the computer readable medium or via a wired and/or wireless network. Upon loading and executing such software code or instructions by the computing system 100, the computing system 100 may perform any of the functionality of the computing system 100 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for dispensing agricultural fluids onto plants present within a field, the system comprising:
a tank configured to store an agricultural fluid including a pesticide and a carrier fluid;
a nozzle configured to selectively dispense the agricultural fluid onto a plant present within the field;
a sensor configured to capture data associated with the plant; and
a computing system communicatively coupled to the sensor, the computing system configured to:
receive an input associated with the pesticide present within the agricultural fluid;
determine a size parameter associated with the plant based on the data captured by the sensor;
determine a selected amount of the pesticide to be dispensed onto the plant based on determined size parameter and the received input associated with the pesticide; and
control an operation of the nozzle such that a volume of the agricultural fluid containing the selected amount of the pesticide is dispensed onto the plant.

2. The system of claim 1, wherein:
the pesticide comprises an active ingredient and an inactive ingredient; and
when receiving the input associated with the pesticide, the computing system is configured to receive an input associated with the active ingredient of the pesticide present within the agricultural fluid.

3. The system of claim 2, wherein:
when determining the selected amount of pesticide, the computing system is configured to determine a selected amount of the active ingredient to be dispensed onto the plant based on determined size parameter and the received input associated with the active ingredient; and
when controlling the operation of the nozzle, the computing system is configured to control the operation of the nozzle such that a volume of the agricultural fluid containing the selected amount of the active ingredient is dispensed onto the plant.

4. The system of claim 2, wherein the input associated with the active ingredient comprises at least one of a type of the active ingredient or a concentration of the active ingredient within the pesticide.

5. The system of claim 1, wherein the size parameter of the plant comprises at least one of a height of the plant, a circumference of the plant, a stalk diameter of the plant, or a biomass of the plant.

6. The system of claim 1, wherein, when controlling the operation of the nozzle, the computing system is configured to control a duty cycle of the nozzle.

7. The system of claim 1, wherein the sensor comprises an imaging device configured to capture image data depicting the plant.

8. The system of claim 1, wherein the computing system is further configured to:
compare the determined size parameter to a maximum size parameter; and
when the determined size parameter exceeds the maximum size parameter, control the operation of the nozzle to prevent the agricultural fluid from being dispensed onto the plant.

9. The system of claim 8, wherein the computing system is further configured to:
when the determined size parameter exceeds the maximum size parameter, geolocate the plant within the field.

10. The system of claim 8, wherein the computing system is further configured to:
when the determined size parameter exceeds the maximum size parameter, initiate notification of an operator.

11. An agricultural sprayer, comprising:
a frame;
a tank supported on the frame, the tank configured to store an agricultural fluid including a pesticide and a carrier fluid;
a boom assembly supported on the frame;
a plurality of nozzles supported on the boom assembly, each nozzle configured to selectively dispense the agricultural fluid onto a plant present within the field;
a sensor configured to capture data associated with the plant; and
a computing system communicatively coupled to the sensor, the computing system configured to:
receive an input associated with the pesticide present within the agricultural fluid;
determine a size parameter associated with the plant based on the data captured by the sensor;
determine a selected amount of the pesticide to be dispensed onto the plant based on determined size parameter and the received input associated with the pesticide;
determine a selected nozzle of the plurality of nozzles to dispense the selected amount of the pesticide; and
control an operation of the selected nozzle such that a volume of the agricultural fluid containing the selected amount of the pesticide is dispensed by the selected nozzle onto the plant.

12. A method for dispensing agricultural fluids onto plants present within a field, the method comprising:
receiving, with a computing system, an input associated with a pesticide present within the agricultural fluid, the agricultural fluid further including a carrier fluid;
receiving, with the computing system, sensor data associated with a plant present within the field;
determining, with the computing system, a size parameter associated with the plant based on the received sensor data;
determining, with the computing system, a selected amount of the pesticide to be dispensed onto the plant based on determined size parameter and the received input associated with the pesticide; and
controlling, with the computing system, an operation of a nozzle such that a volume of the agricultural fluid containing the selected amount of the pesticide is dispensed onto the plant.

13. The method of claim 12, wherein:
the pesticide comprises an active ingredient and an inactive ingredient; and
receiving the input associated with the pesticide comprises receiving, with the computing system, an input associated with the active ingredient of the pesticide present within the agricultural fluid.

14. The method of claim 13, wherein:
determining the selected amount of pesticide comprises determining, with the computing system, a selected amount of the active ingredient to be dispensed onto the plant based on determined size parameter the received input associated with the active ingredient; and
controlling the operation of the nozzle comprises controlling, with the computing system, the operation of the nozzle such that a volume of the agricultural fluid containing the selected amount of the active ingredient is dispensed onto the plant.

15. The method of claim 13, wherein the input associated with the active ingredient comprises at least one of a type of the active ingredient or a concentration of the active ingredient within the pesticide.

16. The method of claim 12, wherein the size parameter of the plant comprises at least one of a height of the plant, a circumference of the plant, a stalk diameter of the plant, or a biomass of the plant.

17. The method of claim 12, wherein controlling the operation of the nozzle comprises controlling, with the computing system, a duty cycle of the nozzle based on the received input.

18. The method of claim 12, further comprising:
comparing, with the computing system, the determined size parameter to a maximum size parameter; and
when the determined size parameter exceeds the maximum size parameter, controlling, with the computing system, the operation of the nozzle to prevent the agricultural from being dispensed onto the plant.

19. The method of claim 18, further comprising:
when the determined size parameter exceeds the maximum size parameter, geolocating, with the computing system, the plant within the field.

20. The method of claim 18, further comprising:
when the determined size parameter exceeds the maximum size parameter, initiating, with the computing system, notification of an operator.
